(19) United States
(12) Patent Application Publication
(10) Pub. No.: US 2017/0027367 A1
(43) Pub. Date: Feb. 2, 2017

(54) DEVICES AND METHODS FOR BEVERAGE BREWER PRESSURE REGULATION

(71) Applicant: Remington Designs, LLC, Valencia, CA (US)

(72) Inventor: Bruce D. Burrows, Valencia, CA (US)

(21) Appl. No.: 15/222,724

(22) Filed: Jul. 28, 2016

Related U.S. Application Data
(60) Provisional application No. 62/199,941, filed on Jul. 31, 2015.

(51) Int. Cl. A47J 31/00; A47J 31/46

(52) U.S. Cl. CPC A47J 31/002; A47J 31/46

(57) ABSTRACT

Systems, methods, and apparatuses for controlling fluid temperature. A beverage brewer in accordance with an aspect of the present disclosure comprises a sensor, a pump, a heating tank, and a controller. The controller is coupled to the sensor, the heating tank, and the pump. The controller selectively activates the pump to deliver a fluid to the heating tank based at least in part on an output of the sensor. A temperature of the fluid is maintained at a desired temperature by the controller.

### CROSS REFERENCE TO RELATED APPLICATIONS

This application claims priority under 35 U.S.C. §119(e) from U.S. Patent Application Ser. No. 62/199,941, filed Jul. 31, 2015 for Bruce D. Burrows and entitled “DEVICES AND METHODS FOR BEVERAGE BREWER PRESSURE REGULATION,” which application is incorporated by reference herein in its entirety.

### BACKGROUND

Field

The present disclosure pertains generally to devices and methods for regulating pressure within a brew cartridge.

Description of the Related Art

In recent years, single serve beverage brewers (e.g., those made by Keurig Green Mountain, Inc., of Waterbury, Vt.) have become popular among consumers. Single serve beverage brewers may include a pump that displaces water from a reservoir to a heater tank for heating. The heated water is then delivered to a beverage formation chamber, such as a brew head. The beverage formation chamber may be configured to hold a single serve beverage container, pod, or cartridge (hereinafter referred to generically as a “cartridge”) containing a beverage medium for mixing with the heated water, such as coffee grounds or other material to mix with the water to make the beverage. The coffee grounds or other beverage medium can be held within, above, or on a filter within the cartridge if desired.

An inlet needle attached to the top piece of the brew head may pierce the lid of the cartridge and an outlet needle may pierce the bottom of the cartridge without piercing the filter. Heated water then runs through the inlet needle into the cartridge, where it is mixed with the beverage medium to form a brewed beverage (e.g., coffee). Differences in pressure created by the flow of the heated water (or other fluid) from the pump to the cartridge forces the fluid through the beverage medium to create the brewed beverage (with the filter catching the beverage medium, such as coffee grounds, if the filter is in place) and the beverage is dispensed from the outlet needle.

As described above, adequate pressurization and liquid flow within the cartridge may be important to ensure effective operation and/or desired beverage creation. Underpressurization and/or too low of a flow to the cartridge can result in inadequate mixing of the fluid and the beverage medium and/or create a reduced output beverage flow.

Overpressurization of the fluid in certain locations within the beverage maker can have undesired results. For instance, overpressurization of the fluid in the region of the cartridge can result in the filter within the cartridge detaching from the cartridge walls (i.e. “blowing out”). This may further result in some of the beverage medium (such as coffee grounds) being dispensed along with the beverage. An even more undesirable result of overpressurization can be the rupture of the cartridge itself, which can result not only in coffee grounds exiting the system with the beverage, but can reduce the convenience of single-serve cartridges in such systems by spillage of the fluid, beverage medium, and/or beverage within the brew head.

### SUMMARY

Aspects of the present disclosure comprise methods and apparatuses for aiding in the consistency of delivery of thermally affected fluids while reducing the effect of thermal gradients or overheating of fluids.

A beverage brewer in accordance with an aspect of the present disclosure comprises a sensor, a pump, a heating tank, and a controller. The controller is coupled to the sensor, the heating tank, and the pump. The controller selectively activates the pump to deliver a fluid to the heating tank based at least in part on an output of the sensor. A temperature of the fluid is maintained at a desired temperature by the controller.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a schematic view of one embodiment of a beverage brewer according to the present disclosure;

FIG. 2 is a flow diagram of one embodiment of a feedback loop according to the present disclosure;

FIG. 3A is a flow diagram of one embodiment of a brew cycle according to the present disclosure;

FIG. 3B is a flow diagram of another embodiment of a brew cycle according to the present disclosure;

FIG. 4 is a schematic view of another embodiment of a beverage brewer according to the present disclosure; and

FIG. 5 is a graph comparing a prior art heating method to one embodiment of a heating method according to the present disclosure.

### DETAILED DESCRIPTION

The present disclosure is directed toward brewing devices and methods for controlling pressure, and preventing or lessening overpressurization, within a brew cartridge. Many prior art devices and methods can result in overpressurization within the brew cartridge, which itself can result in the filter in the cartridge structurally failing (e.g. “blowing out”). This failure can result in the dispensing of an undesirable amount of solids with the desired liquid from the cartridge. Another potential result of overpressurization is the structural failure of the cartridge itself, which can result in liquid and solid within the brew head outside of the cartridge, which may increase clean-up efforts and endanger users.

Embodiments of methods according to the present disclosure can utilize different system measurements to detect an overpressurization and prevent the above negative results. The amount of current drawn by a brewer pump is an indicator of pressure, as the pump must draw more current to overcome the higher pressure. A microcontroller or other device can receive pump current readings from an ammeter and make a determination as to whether current level is above or below a desirable current or current range. The microcontroller can then adjust pump voltage, which in turn adjusts the volume of water pumped. If overpressurization is occurring, this feedback loop can adjust the pump voltage to lessen the amount of liquid being pumped, thus addressing the pressure issue. Similarly, if underpressurization is occurring, the pump voltage can be adjusted.

Embodiments of other methods according to the present disclosure can include remedial action taken in order to prevent or lessen the chance of failure due to overpressurization, or alternatively to prevent or lessen the effects of failure. For example, upon overpressurization, a microcontroller can immediately reduce or cut off power to the brewer heating element. In another method, once a “point of no return” has been crossed and failure is inevitable or likely, the brewer can lock the brew head closed for a period of time until danger—such as pressure within the brew head or hot water loose in the brew head—is lessened or eliminated. Many different embodiments utilizing various preventative measures are possible.

Embodiments of devices according to the present disclosure can include components to prevent the overpressurization situations described above. One such component is a pressure regulator bypass. Under normal operating conditions, liquid will flow from the pump through an open solenoid valve, bypassing a conduit branch including a pressure regulator. However, upon detection of overpressurization, the solenoid valve can close and force liquid through the pressure regulator, thus directly reducing the brewer system pressure and lessening the chance of cartridge failure due to overpressurization.

Embodiments of further methods according to the present disclosure can address one primary cause of cartridge overpressurization—namely, overheating of water within the brewer heater tank. Prior art methods may heat liquid within the tank until it is at or near the desired brewing temperature. However, even after heating element shut-off, heat continues to transfer from the heating element and heater tank to the water. This can cause overheating and thus overexpansion of the water. One embodiment of a method according to the present disclosure utilizes a servo loop and, in one embodiment, a PD controller in order to lessen or prevent one or both of 1) overshoot of a desired temperature, and 2) settling time (i.e., the amount of time until the liquid is at or consistently near the desired temperature).

The present disclosure is described herein with reference to certain embodiments, but it is understood that the disclosure can be embodied in many different forms and should not be construed as limited to the embodiments set forth herein. In particular, the present disclosure is described below in regards to certain modules having features in different configurations, but it is understood that the present disclosure can be used for many other modules and/or configurations. The modules and systems can also have many different shapes beyond those described below.

All physical dimensions, weights, temperatures, etc. in the description and attached drawings are exemplary in nature. It is understood that embodiments of the present disclosure can have various dimensions/weights/temperatures/etc. varying from those shown in the attached drawings.

It is also understood that when a feature or element may be referred to as being “on” another element, it can be directly on the other element or intervening elements may also be present unless specifically stated otherwise. Furthermore, relative terms such as “inner”, “outer”, “upper”, “above”, “lower”, “beneath”, and “below”, and similar terms, may be used herein to describe a relationship of one element or attribute to another. With regard to the figures, it is understood that these terms are intended to encompass different orientations of the device in addition to the orientation depicted.

Although the terms first, second, etc. may be used herein to describe various elements, components, regions, and/or sections, these elements, components, regions, and/or sections should not be limited by these terms. These terms are only used to distinguish one element, component, region, or section from another region, or section. Thus, a first module, element, component, region, or section discussed below could be termed a second module, element, component, region, or section without departing from the teachings of the present disclosure.

Embodiments of the disclosure are described herein with reference to cross-sectional view illustrations that are schematic illustrations of embodiments of the disclosure. As such, the actual dimensions of elements can be different, and variations from the shapes of the illustrations as a result, for example, of manufacturing techniques and/or tolerances are expected. Embodiments of the disclosure should not be construed as limited to the particular shapes of the regions illustrated herein but are to include deviations in shapes that result, for example, from manufacturing. A region illustrated or described as square or rectangular may have slightly rounded or curved features due to normal manufacturing tolerances. Thus, the regions illustrated in the figures are schematic in nature and their shapes are not intended to illustrate the precise shape of a region of a device and are not intended to limit the scope of the disclosure. It is understood that the shapes, sizes, and locations in the attached figures may not be to scale.

Overpressurization within beverage systems may result from many different factors. One factor can be the overheating (and thus overexpansion) of water or other liquids used in the creation of a beverage. Such overheating can occur under many conditions, and in some machines can occur if the water in the heater tank is at a colder temperature at the beginning of a brew cycle, such as ambient (instead of, for example, a pre-heated temperature such as 140° F.).

The brewer may detect the relatively cold state of the water and endeavor to rapidly heat the water in the heater tank, operating at higher power levels to reduce total beverage preparation time. However, this rapid attempt to heat the fluid can cause a temperature overshoot—even after the heater is turned off, because there is hysteresis in the temperature control system of some beverage making systems.

Both before and after heater turn-off, the thermal system of the heater, heater tank, and water therein moves toward equilibrium through the transfer of heat from the heater to the heater tank and water (and other transfers, such as from the heater tank to the water). When the heater is turned off, no more energy (i.e., heat) will be added to the thermal system. However, the system never reach equilibrium during the brew cycle while the heater is operating; the fluid temperature fluctuates based on the hysterisis in the system and the thermal capacity of the fluid. Thus, after heater turn-off, the water temperature will continue to rise while the system moves toward equilibrium. This continued heating, and overheating in general, may cause water being pumped to the cartridge to expand in volume. This expanded volume can result in overpressurization within the cartridge, and the possibility of undesired results may increase.

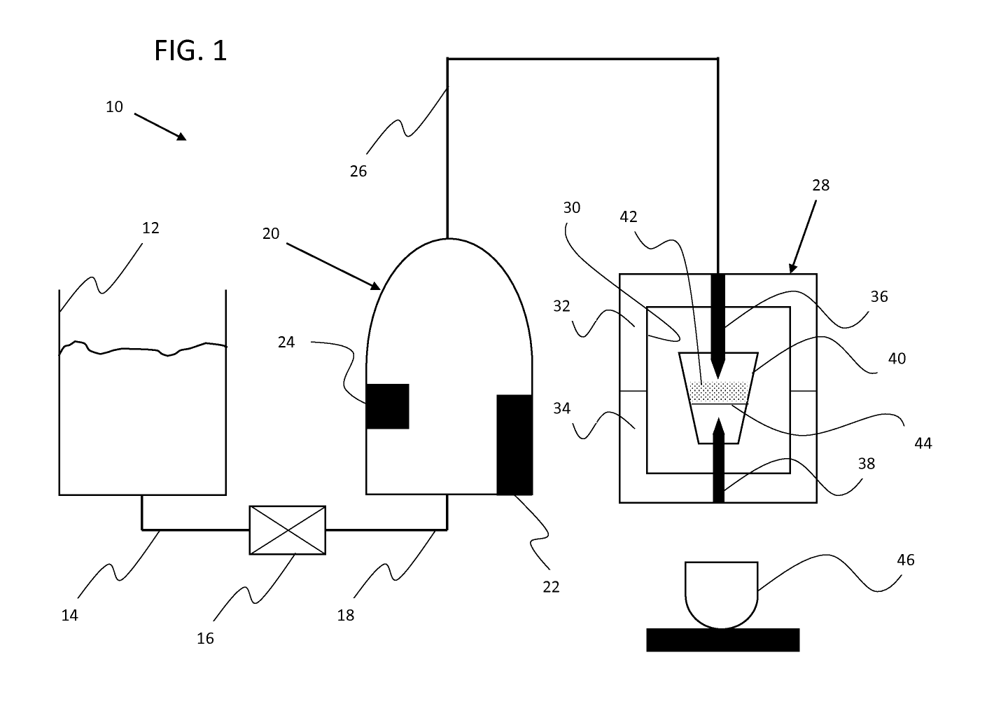

FIG. 1 is a schematic view of a brewer 10 according to one embodiment of the present disclosure. While the term “brewer” is used generically herein, it is understood that this term can include machines for the formation of any type of liquid, such as hot and cold brewed beverages, non-brewed beverages, soups, etc. Further, the brewer 10 can include many different components and features not shown in FIG. 1. Some of these components and features are described, for example, in PCT Pat. App. No. PCT/US15/15971 to Burrows, filed Feb. 13, 2015 and entitled “Beverage Brewer and Related Methods for Brewing Beverages”; U.S. Provisional Pat. App. No. 62/136,258 to Burrows, filed Mar. 20, 2015 and entitled “Coffee Brewing System and Method of Using the Same”; and PCT Pat. App. No. PCT/U515/25013 to Burrows, filed Apr. 8, 2015 and entitled “Beverage Brewing Systems and Method for Using the Same”; each of which is fully incorporated by reference herein in its entirety.

The brewer 10 can include a reservoir 12 which can store water for use by the brewer. The reservoir 12 can be connected to a pump 16 via a first conduit 14. The pump 16 can be connected to a heater tank 20 via a second conduit 18. In alternative embodiments, the pump can instead be attached to the reservoir or in many other locations, and the specific embodiment shown in FIG. 1 should not be considered limiting.

The heater tank 20 can include one or more heating elements 22 therein or connected thereto, as well as a temperature sensor 24 such as a thermistor. Hotter water rises above colder water, meaning that colder water in the heater tank 20 will be below hotter water. As such, it can be advantageous to include the heating element 22 at a lower position in relation to the heater tank 20 such that it is heating colder water.

The heater tank 20 can be connected to a brew head 28 via a third conduit 26, although other embodiments are possible. The brew head 28 can include a brew chamber 30 therein. Top and bottom components 32, 34 of the brew head 28 can include needles 36, 38 (which themselves contain one or more conduits) attached thereto; it is understood that the term “needle” is used generically herein, and many different piercing devices or other devices can be used. In the specific embodiment shown, the top needle 36 is an inlet needle and the bottom needle 38 is an outlet needle, and will be referred to as such throughout herein, although many different locations for inlet and outlet needles according to the present disclosure are possible.

One or both of the top and bottom components 32,34 can be movable in order to place the brew head 28 in an “open” position, where the brew chamber 30 is exposed. When the brew head 28 is open, a user can insert a cartridge 40 (or other container) into the brew chamber 30. A embodiment of the cartridge 40 can contain beverage medium 42 (e.g., coffee grounds) and a filter 44. In one embodiment, the bottom component 34 is stationary and the top component 32 is opened to expose the brew chamber 30. When the user places the cartridge 40 into position and the brew chamber 30 is moved to a closed position, the outlet needle 38 can pierce the bottom of the cartridge 40. When the brew head 28 is closed by replacing the top component 32, the inlet needle 36 can pierce the top of the cartridge 40. Many other embodiments are possible; for example, in one embodiment the cartridge 40 is not pierced by either of the needles 36, 38 until the brew head 28 is closed. In another embodiment, both the top and bottom components 32, 34 open and close. The above specific embodiments should not be considered to be limiting. A liquid reception area can be beneath the brew head 28, and a receptacle 46 can be placed in the reception area to receive liquid (i.e., the beverage) from the brew head 28.

In a embodiment of a brewer according to the present disclosure, after the first use of the brewer “out-of-the-box,” a volume of water sufficient for one brew cycle (i.e., one operation of the brewer resulting in a serving of liquid being dispensed) will remain within the heater tank 20. During periods of non-use of the brewer 10, this water may cool.

In some embodiments, the heating element 22 may keep the water in the heater tank 20 at a pre-heated temperature (e.g., 140° F.) for a period of time, or whenever the brewer 10 is connected to a power source. In one embodiment, the water in the heater tank 20 may be permitted to reach ambient temperature. The water will also be at or near ambient temperature during the first “out-of-the-box” fill of the heater tank 20. Upon initiation of a brew cycle the water in a heater tank 20 will need to be heated in order to brew the beverage medium 42 within a cartridge 40 sufficiently. Under certain circumstances the water may become overheated and increase in volume beyond a desired point even after the heating element 22 is turned off. In one embodiment, this can be partially or wholly caused by a delay in temperature reading due to the sensor 24. For instance, a sensor 24 embodied by a thermistor may cause a delay of 10 seconds or even more in recognizing the temperature of the fluid; as such, by the time the desired temperature is recognized, it has in reality been exceeded.

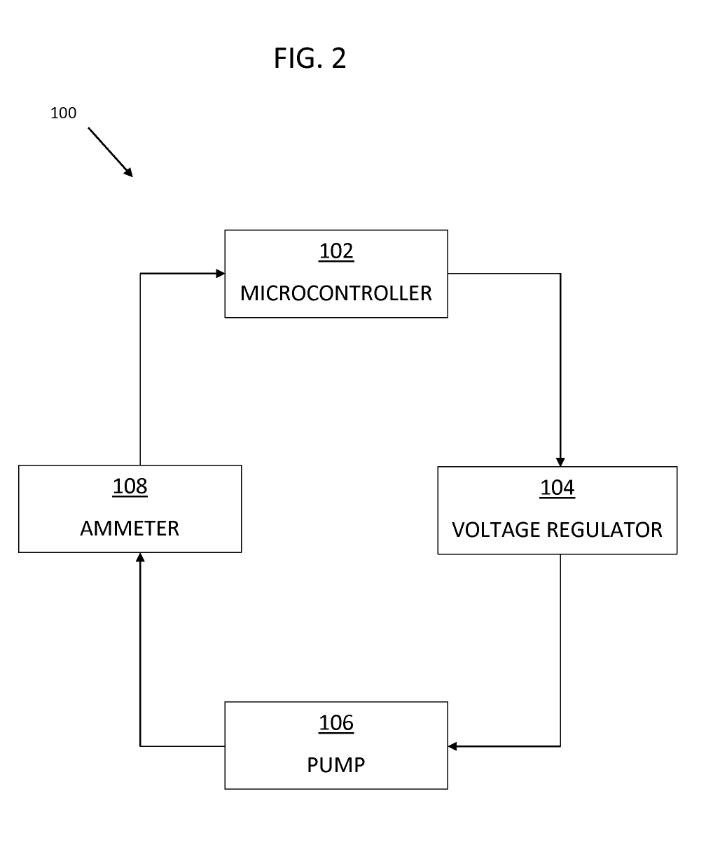

The brewer 10 can include a controller or other processing unit, such as a microcontroller 102, shown schematically in FIG. 2. The microcontroller 102 may include an internal and/or external memory (not shown) and can serve many different functions. For example, in one embodiment, the microcontroller 102 may serve to regulate the power provided to the heating element 22 based on information provided by the temperature sensor 24 or other sensors. Many different functions are possible.

Microcontrollers 102 according to embodiments of the present disclosure can provide functionality that can prevent or lessen the chance of overpressurization or underpressurization of a cartridge 40. FIG. 2 shows a feedback loop 100 designed to regulate the voltage provided to a pump 106, which can be similar to or the same as the pump 16 from FIG. 1. The voltage provided to the pump 106 in a brewer relates to the amount of work performed by the pump (e.g., in one example, the higher the voltage, the higher the pump torque); the amount of work performed may be relative to the volume of fluid displaced. Thus, an increase in voltage may result in more fluid displacement from the pump 106, while a decrease in voltage results in less fluid displacement. Because pressure in the cartridge 40 is related to the volume of water pumped therein, regulating the voltage to the pump 106 may regulate the amount of pressure in the cartridge 40.

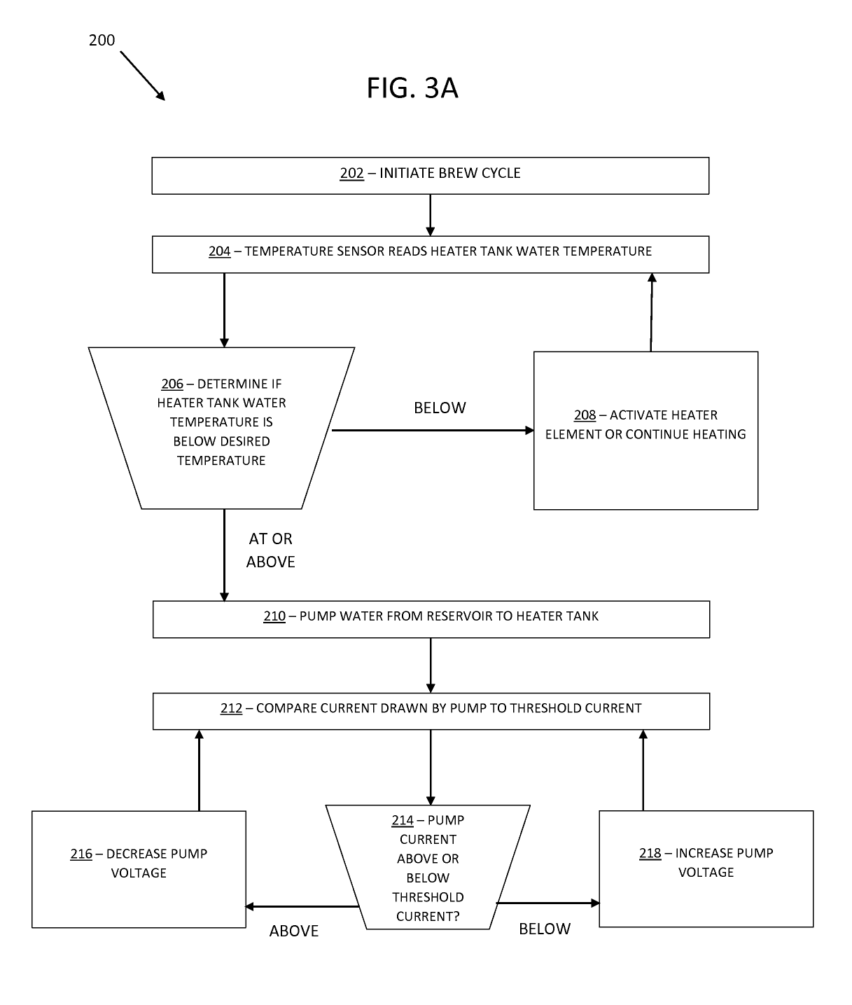

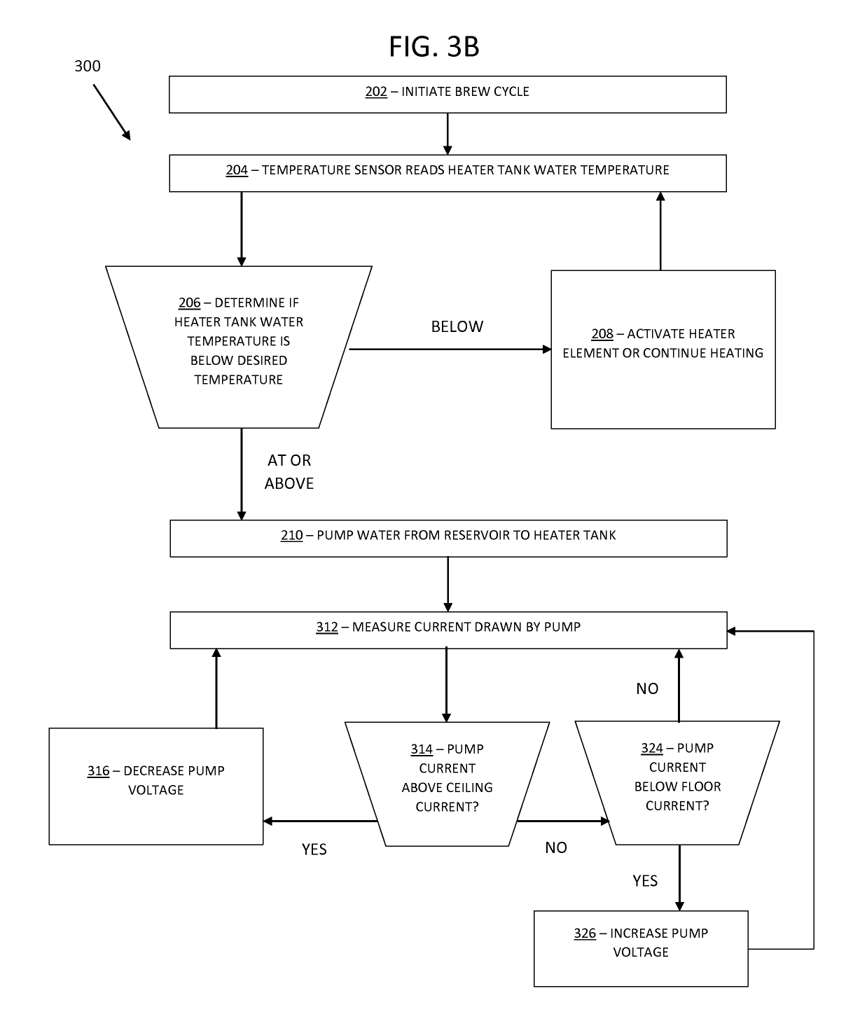

According to an embodiment of the present disclosure, the microcontroller 102 can use amperage readings to effectively regulate pump voltage and, thus, cartridge 40 pressure. An ammeter 108 can measure the amount of current drawn by the pump 106, and transmit this information to the microcontroller 102. The microcontroller 102 can use this information, and other information such as the temperature sensor 24 information, to determine how the current level relates to desired threshold current value(s), which is discussed with regard to FIGS. 3A and 3B.

The microcontroller 102 can then use this information to determine a desired voltage, and send a signal with this information to a voltage regulator 104 or directly control the voltage delivered to pump 106. The voltage regulator 104 can modify an input voltage provided by a power supply based upon the signal from the microcontroller 102. This modified voltage can then be delivered to the pump 106, thus altering the volume of fluid being displaced. Readings by the ammeter 108 can be taken at many different intervals depending upon the specificity of control desired. Thus, by taking readings of the current drawn by the pump 106, the voltage to the pump 106 can be controlled in order to adjust the amount of fluid displacement from the pump 106, which may assist in controlling the pressure within the cartridge 40.

FIG. 3A shows one embodiment of a brew cycle 200 including cartridge 40 pressure regulation according to the present disclosure. The brew cycle 200 can take place in, for example, a brewer similar to or the same as the brewer 10 from FIG. 1, and can include a feedback loop similar to or the same as the feedback loop 100 from FIG. 2. Upon initiation of a brew cycle in the step 202, such as by a user pressing a button, in the step 204 a temperature sensor such as the temperature sensor 24 from FIG. 1 can read the temperature of water in a heater tank, such as the heater tank 20. If the water in the heater tank is below a desired temperature as determined in the step 206, one or more heating elements such as the heating element 22 can be activated in the step 208 or, if already activated, can continue heating. The step 204 can continue to take place, such as continuously or at a desired frequency, until the sensor determines that the water in the heater tank is at (or above) the desired temperature. Upon reaching (or exceeding) the desired temperature, in the step 210 water can be pumped from a reservoir, such as the reservoir 12 from FIG. 1, to the heater tank, which can cause displacement of the water within the heater tank from the heater tank to the cartridge 40. The water can be pumped by, for example, a pump similar to or the same as the pump 16 from FIG. 1.

Upon the beginning of pumping in the step 210, a feedback loop similar to or the same as the feedback loop 100 from FIG. 2 can begin. In the step 212, the current being drawn by the pump can be measured, such as using an ammeter, and this reading can be sent to a microcontroller. This current reading can vary based on a number of different factors, including but not limited to the brew cartridge 40 pressure (higher current being related to higher pressure, since the pump must overcome more pressure). In the step 214, the current can be compared to a threshold current to determine if it is higher or lower than the threshold, the threshold current being a predetermined value above which overpressurization may occur and under which underpressurization may occur. This comparison can be done by the microprocessor. Many different threshold currents can be used, with one appropriate threshold current being approximately 225 mA. The threshold current can also be varied throughout different parts of the brew cycle, such as those described in PCT Pat. App. No. PCT/US15/25013 to Burrows. The threshold current can also vary depending upon the type of cartridge 40 used; for instance, in one embodiment a sensor can determine the type of cartridge 40 in the brew head, and the threshold current(s) can be adjusted accordingly, such as by microcontroller 102.

If the current is determined to be above the threshold in the step 214, the voltage supplied to the pump can be reduced in the step 216, such as by a voltage regulator. Alternatively, if the current is determined to be below the threshold in the step 214, the voltage supplied to the pump can be increased in the step 218. This process can then repeat itself beginning with the step 212. In one embodiment, this process may repeat for a desired period of time over which the pump 16 is operating.

FIG. 3B shows another embodiment of a brew cycle 300 including cartridge 40 pressure regulation according to the present disclosure. The brew cycle 300 is similar in many respects to the brew cycle 200 from FIG. 3A, with equivalent indicator numerals representing equivalent steps. The brew cycle 300 can include the steps 200-210 described with regard to FIG. 3A, but can include a different feedback loop which can allow for a range of acceptable currents which do not employ a voltage adjustment.

In the step 312, the current being drawn by the pump 16 can be measured, such as using an ammeter, and this reading can be sent to microcontroller 102. In the step 314, the current can be compared to a predetermined ceiling value. If the current is above the ceiling value, the voltage regulator can reduce the pump voltage in the step 316, and the feedback loop can be restarted at the step 312. If the current is below the ceiling value, then another comparison of the current can be made; namely, the current can be compared to a predetermined floor value in the step 324. If the current is above the floor value, then the feedback loop can be restarted at the step 312 without a voltage adjustment being made. If the current is below the floor value, then the voltage regulator can increase the pump voltage in the step 326, and the feedback loop can be restarted in the step 312. Many different ceiling and floor current values can be used, with one example having a ceiling current of 235 mA and a floor current of 215 mA, although many different values and ranges are possible. The ceiling current and/or the floor current can also be varied throughout different parts of the brew cycle, such as those described in PCT Pat. App. No. PCT/US15/25013 to Burrows. Also similar to the above embodiment, ceiling and floor currents can be varied based on cartridge 40.

The voltage adjustment described above can be made using any method known in the art, such as, for example, pulse width modulation (PWM) or regulation of the duty cycle. Furthermore, embodiments of the present disclosure can use either alternating current (AC) or direct current (DC).

While the above embodiments describe cartridge 40 pressure regulation via pump voltage adjustment based on the current being drawn by the pump, pressure regulation according to the present disclosure can be based on many other factors. An overpressurization of the cartridge 40 can be detected based on trigger events other than the amount of current being drawn by the pump. For example, in one embodiment a pressure transducer is used to measure pressure directly. In another embodiment, a drop in flowrate of liquid out of the cartridge 40 can indicate a pressure build-up within the cartridge 40. Many different methods of detection are possible.

Systems according to the present disclosure can use one or more measurements in an effort to recognize a trigger event which can indicate the possibility or inevitability of cartridge 40 failure in order to take remedial action. Different characteristics of the system, such as cartridge 40 pressure, current drawn by the pump, pump voltage, etc., can vary throughout a brew cycle. However, this variance may be expected and can be represented as a function of time. Systems according to the present disclosure can measure a system characteristic and compare the value of the characteristic to the expected value. If the characteristic value varies from the expected value (e.g., output flow from the cartridge 40 is lower than expected, or current drawn by the pump is higher than expected) by a predetermined amount, then the system can take remedial action in an effort to prevent cartridge 40 failure due to overpressurization.

In one embodiment according to the present disclosure, the reaching of a characteristic threshold (a “first” threshold) can indicate the possibility of a cartridge 40 failure. Upon reaching this first threshold, the system can take remedial action in an effort to prevent cartridge 40 failure. Some exemplary remedial actions include the shutting down of the system heating elements, such as the heating element 22 of FIG. 1, or a reduction in pump voltage (or stoppage of the pump) in order to cause a reduction in pressure build-up. Many other remedial actions, including combinations thereof, are possible, and can prevent and/or lessen the risk of cartridge 40 failure.

Systems according to the present disclosure can also take remedial action upon the reading of a failure threshold, such as a failure flowrate threshold and/or a failure pressure threshold. Such action can be in addition to the remedial actions described above, or can stand alone. A failure threshold as discussed herein can be reached, for example, if a cartridge 40 has already failed, or if the measured characteristic indicates that the system has reached a “point of no return” such that failure is imminent and practically or completely unavoidable. Different systems may define a “failure threshold” differently, and the above examples should not be considered limiting.

Upon reaching a failure threshold, the system can react. In one embodiment, the brew head of a brewer, such as the brew head 28 from FIG. 1, is locked and cannot be opened by a user for a period of time. For example, U.S. Provisional Pat. App. No. 62/136,258 to Burrows describes the use of a safety solenoid which can lock a brew head in a closed position. Locking a brew head can prevent a user from opening the brew head during or after failure for a predetermined or calculated period of time during which the danger posed by opening the brew head can dissipate. For example, the pressure within the brew head can be permitted to bleed off, such as through an outlet needle such as the outlet needle 38 from FIG. 1. The locking time of the system can be predetermined, or can be based upon a measured value such as pressure within the brew head such that the brew head will not open until such opening is relatively safe.

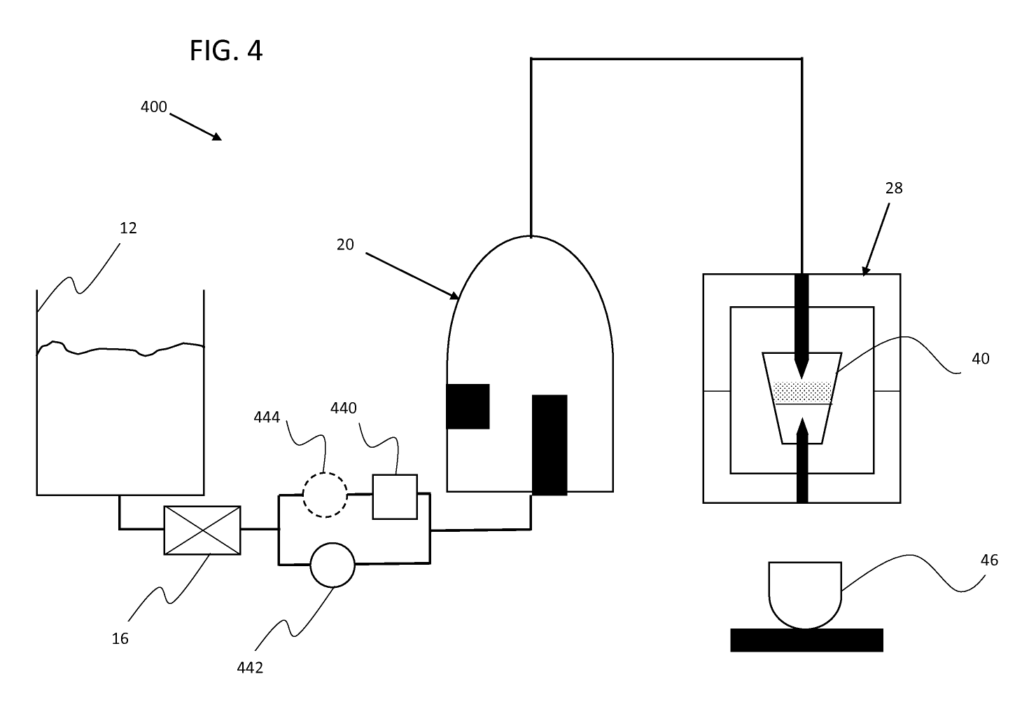

Another form of remedial action according to the present disclosure can involve a pressure regulator bypass. FIG. 4 shows a brewer 400 that can contain many components that are similar to or the same as the brewer 10 from FIG. 1, although other embodiments including the pressure regulator bypass described herein are possible. The brewer 400 can also include a pressure regulator 440 and a solenoid 442. In the embodiment shown, the pressure regulator 440 and solenoid 442 are located between the pump 16 and the heater tank 420, although other embodiments are possible.

The pressure regulator 440 and the solenoid 442 can be arranged in parallel, although other embodiments are contemplated. In one embodiment, the pressure regulator 440 and solenoid 442 are arranged such that when the solenoid 442 is open, all or substantially all of the water from the pump 16 passes through the open solenoid 442 and not the pressure regulator 440, and when the solenoid 442 is closed, all or substantially all of the water from the pump 16 passes through the pressure regulator 440. An alternative embodiment can include a second solenoid 444 which can either allow or block flow through the branch including the pressure regulator 440. The second solenoid 444 could be closed, and could open simultaneously with or nearly simultaneously with the closure of the first solenoid 442.

Bypassing the pressure regulator 440 can allow for adequate pressure in nearly all situations, while use of a pressure regulator can sometimes result in underpressurization under certain conditions. For example, a pressure of 3 psi produces a satisfactory brew time for a given cartridge 40, but at 3 psi the brew time can double for a reusable cartridge 40 overpacked with beverage medium 42 by a user. As previously stated, in one embodiment all or substantially all flow bypasses the pressure regulator 440, such as through an open solenoid such as the solenoid 442. However, upon the recognition by the system of a certain characteristic threshold such as a first or failure threshold described above, the brewer 400 can take remedial action by closing the solenoid 442 such that all or substantially all flow thereafter from the pump 416 is forced through the pressure regulator 440. The pressure regulator 440 can then control the flow such that system pressure drops to an acceptable and safe level, such as, for example, 3 psi. This remedial action can prevent or lessen the possibility of the previously described cartridge 40 failures.

Embodiments of the present disclosure can use other systems and methods for the regulation of cartridge 40 pressure. One such embodiment can include regulation of a heating element in order to control the heating—and thus volume expansion—of water within a heater tank. As previously described, especially in situations where the water within a heater tank is at a relatively low temperature, heating of the water can result in temperature overshoot such that the water reaches a temperature higher than that desired, which can result in the overpressurization of the cartridge 40. This can be due to, for example, a delay in feedback from a thermistor, such that when system recognizes the water in the heater tank as being at the desired temperature, it has actually already surpassed this temperature. Another potential cause of overshoot previously described is the heat transferred to the water after heating element shut-off, which is not taken into account by many prior art systems. Many different causes are possible.

One embodiment of the present disclosure can utilize a servo loop, which can correct for the overheating of water in the heater tank. A microcontroller, which in one embodiment can be the same microcontroller of FIG. 2 described above with regard to other functionality, can serve as a proportional-integral-derivative controller (PID controller) and/or a proportional-derivative controller (PD controller). It is noted that other types of controllers, such as a PI controller, are possible. The proportional (“P”) value in such controllers may be dependent upon the actual error between the measured temperature and the desired temperature, while the derivative (“D”) value may be dependent upon the rate of change in the characteristic being measured.

An embodiment of the present disclosure may utilize a PD microcontroller, such as shown in FIG. 2. Thus, both a P value and a D value are used to determine the amount of power to the heating element. As the measured temperature nears the desired temperature, the P value gets smaller, which can result in lower power values to the heating element. When the D value is recognized as being positive (i.e., change in temperature is positive), the power to the heating element can be reduced. This reduction can be in an amount related to the actual D value (e.g., with a larger D value, a large power reduction can be made, and with a smaller D value, a small power reduction can be made). Similarly, a negative D value can result in more power being sent to the heating element.

The use of a D term in addition to a P term may eliminate or reduce temperature oscillation of the fluid about the desired temperature which may be disadvantageous. The use of the PD microcontroller (e.g., microcontroller 102) in this manner can result in critical damping of the thermal property of the fluid, e.g., the temperature of the water within the tank more smoothly approaches the desired temperature 1) with a reduced (if any) overshoot of the desired temperature, and/or 2) reduced settling time to a nearly constant or practically constant temperature.

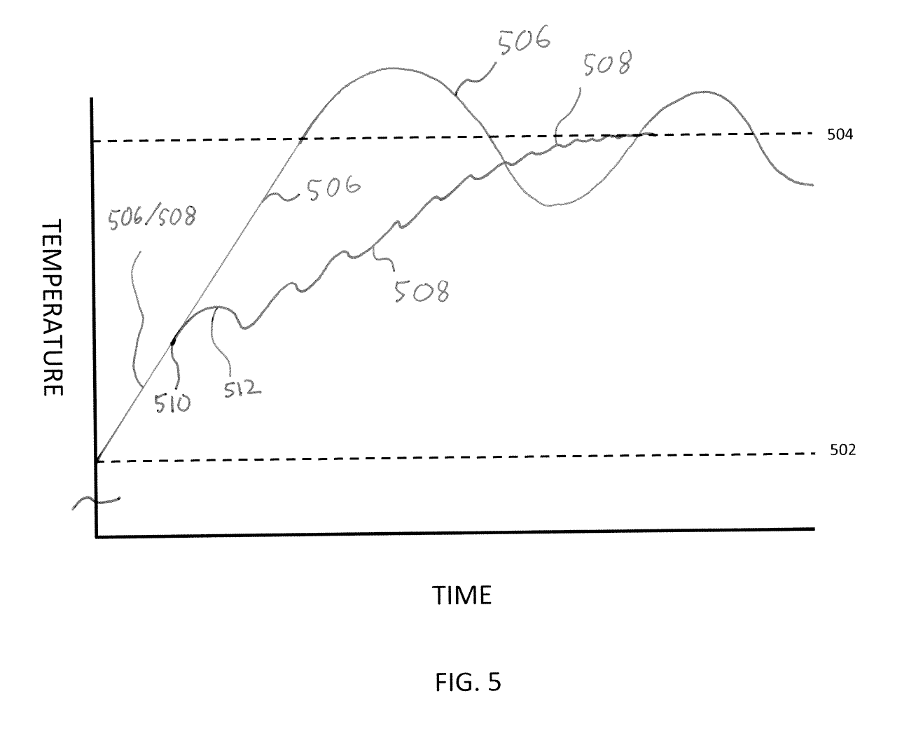

FIG. 5 shows a graphical comparison between a prior art heating method and a heating method according to one embodiment of the present disclosure, with the line 502 representing a starting temperature below the desired temperature, and the line 504 representing the desired temperature. A prior art heating method is represented by the line 506. As shown by the prior art line 506, in a prior art embodiment power to the heating element is not cut or reduced until a sensor recognizes that the water temperature is at the desired temperature (which, as previously described, may even be after a sensor delay time, meaning that the water is actually already above the desired temperature). The water temperature then greatly overshoots the desired temperature, and power will not be added to the heating element again after the sensor recognizes a temperature below the desired temperature. This method results both in a large overshoot and increased settling time.

A heating method according to one embodiment of the present disclosure is represented by the line 508. Upon recognizing a large D value at the point 510, power to the heating element can be reduced, resulting in a reduction in the D value until the D value becomes zero at the local maximum shown by the point 512 and negative for a period thereafter (in some embodiments, the D value does not become negative, but instead only reaches zero). After the D value becomes negative, the microcontroller can again power the heating element, resulting in the recovery of the D value to a positive value. In another embodiment, this action can be taken when the D value approaches zero or is zero. This process can be repeated as temperature approaches the desired temperature. Further, the overall magnitude of the power increase and reduction to the heating element can be reduced as the temperature gets closer to the desired temperature—i.e., as the P value is reduced. As shown, this process results in a reduced and/or minimal overshoot and reduced settling time.

The memory, which may be internal or external to microcontroller 102 may be implemented in firmware and/or software implementation. The firmware and/or software implementation methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit (e.g., microcontroller 102). Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to brewers. Of course, if the brewer is inverted, above becomes below, and vice versa. Additionally, if oriented sideways, above and below may refer to sides of a brewer. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A beverage brewer, comprising:
a sensor;
a pump;
a heating tank; and
a controller, coupled to the sensor, the heating tank, and the pump, in which the controller selectively activates the pump to deliver a fluid to the heating tank based at least in part on an output of the sensor, such that a temperature of the fluid is maintained at a desired temperature.

2. The beverage brewer of claim 1, in which the sensor is a temperature sensor.

3. The beverage brewer of claim 1, in which the controller comprises a Proportional Integral Derivative (PID) controller.

4. The beverage brewer of claim 1, in which the controller comprises a Proportional Derivative (PD) controller.

5. The beverage brewer of claim 1, in which the controller selectively activates the pump by altering a voltage delivered to the pump.

6. The beverage brewer of claim 1, further comprising an ammeter, coupled to the controller and to the pump.

7. The beverage brewer of claim 6, in which the controller further selectively activates the pump by comparing a current drawn by the pump to a threshold current.

8. The beverage brewer of claim 7, in which the controller varies a voltage delivered to the pump based at least in part on a comparison between the current drawn by the pump to the threshold current.

9. The beverage brewer of claim 8, further comprising a voltage regulator coupled to the controller and to the pump.

10. The beverage brewer of claim 9, in which the controller varies the voltage based at least in part on a feedback loop comprising the controller, the ammeter, the voltage regulator, and the pump.
